(19) United States
(12) Patent Application Publication
(10) Pub. No.: US 2022/0371957 A1
(43) Pub. Date: Nov. 24, 2022

(54) COPOLYMER AND HYDRAULIC BINDER COMPOSITION

(71) Applicant: COATEX, Genay (FR)

(72) Inventors: Benoit MAGNY, Cailloux Sur Fontaines (FR); Michel MELAS, Montanay (FR); Laurie PARRENIN, Villeneuve (FR); Jean-Marc SUAU, Lucenay (FR)

(73) Assignee: COATEX, Genay (FR)

(21) Appl. No.: 17/621,304

(22) PCT Filed: Jun. 23, 2020
(86) PCT No.: PCT/FR2020/000190

§ 371 Date: Dec. 21, 2021

(30) Foreign Application Priority Data
Jun. 26, 2019 (FR) FR1906925

(51) Int. Cl. C04B 24/26; C04B 24/16

(52) U.S. Cl. CPC C04B 24/2647; C04B 24/165; C04B 24/267; C04B 2103/32

(57) ABSTRACT

A copolymer may be obtained by polymerization reaction(s) using an anionic monomer and two polyethoxylated monomers. Such copolymers may have a polydispersity index, determined by size exclusion chromatography (SEC), of less than 3, and be obtained by at least one radical polymerisation reaction in water at a temperature ranging from 10 to 90° C. A composition may include such copolymers. Such copolymers may be prepared and use as a superplasticizer for a hydraulic binder composition.

The invention relates to a copolymer obtained by a polymerisation reaction using an anionic monomer and two polyethoxylated monomers. The invention also relates to a composition comprising this copolymer, as well as to a method of preparing and using it as a superplasticising agent in a hydraulic binder composition.

The copolymer according to the invention is advantageously used in the technical field of mortars, concretes, plasters or other compositions based on hydraulic compounds or binders, particularly on cement or on plaster. Such compositions can be advantageously used in the fields of construction and public works, or in the exploitation of hydrocarbons.

Dispersant compounds of hydraulic binders are typically used for their ability to change the rheology of the medium in which they are present, in particular for their ability to control the workability of this medium.

Workability is usually defined as the property of a composition comprising a hydraulic binder, in particular a slag or a cement slurry or mortar slurry, or concrete, for example ready-mix concrete or precast concrete, to remain workable for as long as possible. Advantageously, controlling workability makes it possible to transport or move the aqueous composition comprising the hydraulic binder, for example when transporting or moving it from one tank to another tank. Workability also makes it possible to control the conditions in which such an aqueous composition is stored. It also makes it possible to pump this composition, or to pump it easily. Controlling the workability of such a composition thus makes it possible to improve the conditions of use, in particular to increase its usage time under satisfactory or effective conditions. In general, the workability of an aqueous composition comprising a hydraulic binder can be assessed by measuring the slump time of the hydraulic binder. In particular, the hydraulic binder or superplasticising agent should make it possible to obtain a composition with a stable, controlled viscosity and, preferably, a viscosity that is stable over a long period.

Preferably, improving the workability of aqueous hydraulic compositions comprising a hydraulic binder should be possible for compositions comprising a small amount of water.

Thus, an important aspect of the invention lies in the provision of an aqueous composition comprising a hydraulic binder with effective workability. Controlling workability should not lead to an alteration of other properties, in particular of mechanical properties, particularly when the composition is newly formed.

The workability of aqueous compositions comprising a hydraulic binder can be assessed by measuring the slump, for example in accordance with standard EN 12350-2. Indeed, slump and workability are proportional.

Slump retention is another property to be controlled in aqueous compositions comprising a hydraulic binder.

These properties are particularly sought for certain applications, for example when filling formwork with an aqueous composition comprising a hydraulic binder.

Another aspect of the invention relates to obtaining an aqueous formulation comprising a hydraulic binder that makes it possible to limit or reduce shrinkage when drying.

Improving the properties of aqueous formulations comprising a hydraulic binder should be achieved without altering the setting of the formulation, in particular without delaying the setting.

Aqueous formulations comprising a hydraulic binder should also have the lowest possible weight ratio of water/hydraulic binder, generally water/cement or W/C, without undergoing any alteration of their properties.

One effect that is also sought in aqueous formulations comprising a hydraulic binder is to make it possible to control the amount of entrained air in the material resulting from the setting of this formulation, which thus makes it possible to avoid or reduce the use of anti-foaming agents in the hydraulic formulation.

In general, aqueous formulations comprising a hydraulic binder should make it possible to improve the mechanical properties of the materials obtained, particularly their mechanical properties when newly formed; these properties can be assessed by measuring the change in the compression strength over time.

In addition, the compounds used in the preparation of aqueous formulations comprising a hydraulic binder should be used in smaller amounts. They should also be highly or fully compatible with the other components of the aqueous formulations comprising a hydraulic binder, in particular by being miscible in all proportions with these other components, in order to avoid or limit the risk of segregation of the components of the aqueous formulation comprising a hydraulic binder.

Increasing the retention time of the properties of aqueous formulations comprising a hydraulic binder must also be sought.

Document WO-2019/020934 describes an aqueous composition comprising a copolymer obtained by polymerisation reaction in the presence of a compound of formula S=C[SC(O)OX]₂ that uses an unsaturated carboxylic anionic monomer and a hydrophobic vinyl monomer. Document WO-2019/020936 also describes an aqueous composition comprising a copolymer obtained by polymerisation reaction in the presence of sodium hypophosphite that uses an unsaturated carboxylic anionic monomer and a hydrophobic vinyl monomer. Document US-2014/051801 describes a comb polymer prepared in the presence of hydrogen peroxide from maleic acid, allyl ether, (meth)acrylic acid and hydroxyalkyl-(meth)acrylate. These copolymers are used in hydraulic binder compositions.

There are known dispersant compounds or superplasticising agents that can be used in aqueous formulations comprising a hydraulic binder. However, these compounds do not make it possible to provide a solution to the problems encountered. In particular, these compounds do not make it possible to maintain a good initial slump level of the aqueous formulations comprising a hydraulic binder in which they are incorporated, while maintaining their workability and without altering their mechanical properties or triggering segregation phenomena.

There is therefore a need for dispersant compounds or superplasticisers for aqueous formulations comprising a hydraulic binder that make it possible to provide a solution to all or part of the problems of the compounds in the prior art.

The invention makes it possible to provide a solution to all or part of the problems encountered with the polymers in the prior art. In particular, the invention makes it possible to obtain copolymers using a particularly effective method of preparation, for example with regard to controlling the temperature of the polymerisation reaction. It is particularly essential to be able to use preparation methods that make it possible to avoid the need for maintaining a low temperature of the reaction medium used during the polymerisation reactions known in the prior art.

Moreover, it is also essential to be able to use preparation methods that make it possible to polymerise unsaturated monomers with different molecular masses M_{W}, for example molecular masses M_{W} ranging from 800 to 5,000 g/mol or 8,000 g/mol measured by SEC, in the presence of comonomers comprising vinyl groups.

Likewise, it is essential to be able to use polymerisation reactions that make it possible to copolymerise monomers with reactivities that limit or impede their polymerisation when using the methods in the prior art.

It is also essential to be able to control these polymerisation reactions, in particular to control the proportions of the polymerised comonomers relative to the proportions of said comonomers introduced during the reaction. The copolymers prepared can therefore comprise comonomer residues in proportions that are identical or similar to the proportions of the monomers used, thus ensuring stability of the copolymer composition.

It is also essential to be able to prepare terpolymers, i.e., polymers derived from the reaction of three different monomers, with improved properties. It is particularly important to be able to prepare terpolymers from monomers chosen for the properties they specifically confer to the final polymer. In particular, the choice of monomers with different chain lengths makes it possible to confer particular properties to the prepared polymers. This choice is particularly useful when preparing comb terpolymers with pendant chains of modular lengths. The properties of these polymers, in particular of these terpolymers, can then be controlled in a particularly effective manner.

The invention thus provides a copolymer with a polymolecularity index P_{I} determined by size exclusion chromatography (SEC), of less than 3, obtained by at least one radical polymerisation reaction in water at a temperature ranging from 10 to 90° C., and in the presence:
of at least one radical-generating compound chosen among hydrogen peroxide, ammonium persulphate, an alkaline metal persulphate, and their respective mixtures or combinations with an ion chosen among Fe^{II}, Fe^{III}, Cu^{I}, Cu^{II} and
of at least one compound chosen among:

(i) a compound comprising phosphorus having the oxidation state I;

(ii) a compound of formula (A):

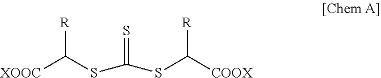

wherein:
X independently represents H, Na or K,
R independently represents a C₁-C₅-alkyl group;

(a) of acrylic acid alone or in combination with at least one monomer chosen among methacrylic acid, maleic acid, maleic anhydride, itaconic acid, 2-acrylamido-2-methylpropane sulphonic acid, 2-acrylamido-2-methylpropane sulphonic, vinylsulphonic acid, 2-(methacryloyloxy)-ethanesulphonic acid, 2-(methacryloyloxy)-ethanesulphonic, sodium methallyl sulphonate, styrene sulphonate and salts thereof;

(b) of at least one monomer chosen among:

(b1) a compound of formula (I):

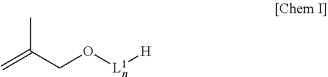

wherein:
L¹ independently represents an EO group or a combination of EO and PO groups;
n independently represents an integer or decimal comprised between 20 and 100;
EO independently represents an ethylene oxide group;
PO independently represents a propylene oxide group;

(b2) a compound of formula (II):

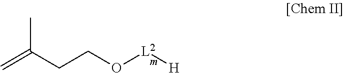

wherein:
L² independently represents an EO group or a combination of EO and PO groups;
m independently represents an integer or decimal comprised between 20 and 100;
EO independently represents an ethylene oxide group;
PO independently represents a propylene oxide group;

(c) of at least one monomer chosen among:

(c1) a monomer of formula (III):

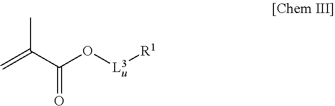

wherein:
L³ independently represents an EO group or a combination of EO and PO groups;
u independently represents an integer or decimal comprised between 22 and 150;
EO independently represents an ethylene oxide group;
PO independently represents a propylene oxide group;
R¹ independently represents H or CH₃;

(c2) a monomer of formula (IV):

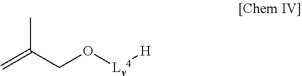

wherein:
L⁴ independently represents an EO group;
EO independently represents an ethylene oxide group;
v independently represents an integer or decimal comprised between 50 and 150;

(c3) a monomer of formula (V):

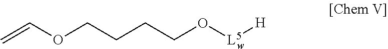

wherein:
L⁵ independently represents an EO group;
EO independently represents an ethylene oxide group;
w independently represents an integer or decimal comprised between 85 and 150;

(c4) a compound of formula (VI):

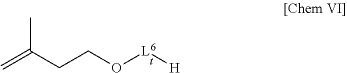

wherein:
L⁶ independently represents an EO group or a combination of EO and PO groups;
t independently represents an integer or decimal comprised between 50 and 150;
EO independently represents an ethylene oxide group;
PO independently represents a propylene oxide group; the set of monomers (c) comprising a total number of EO and PO groups that is 1.3 to 2.5 times greater than the total number of EO and PO groups of the set of monomers (b).

Thus, essentially according to the invention, the total number by weight of the EO and PO groups of all monomers (c) is 1.3 to 2.5 times greater than the total number by weight of the EO and PO groups of all monomers (b). Preferably according to the invention, monomers (c) comprise a total number of EO and PO groups that is 1.4 to 2.5 times greater than the total number of EO and PO groups of monomers (b). According to the invention, the copolymer of the invention characterised by such ratios makes it possible to substantially reduce the amount of water in a hydraulic binder composition. The monomers used in the preparation of the copolymer according to the invention comprise EO groups or comprise a combination of EO groups and PO groups. According to the invention, EO represents an ethylene oxide group. This is a group of formula —CH₂-CH₂O—. According to the invention, PO represents a propylene oxide group. This is a group of formula —CH₂CH(CH₃)O— or a group of formula —CH(CH₃)CH₂O—.

According to the invention, when the copolymer according to the invention comprises a combination of EO groups and PO groups, the total number of EO groups is strictly greater than the total number of PO groups. Preferably, the proportion by weight of the number of EO groups and the number of PO groups ranges from 98/2 to 52/48, preferably from 85/15 to 55/45, more preferably from 80/20 to 60/40 or from 75/25 to 65/35, in particular 70/30.

The conditions for preparing the copolymer according to the invention are particularly advantageous. Indeed, these conditions for preparing the copolymer according to the invention make it possible to reduce or avoid the formation of any homopolymer of monomer (a). Very advantageously, the copolymer according to the invention comprises no homopolymers of monomer (a). Also very advantageously, the copolymer according to the invention comprises no copolymers of monomers (a). According to the invention, these copolymers of monomers (a) are copolymers of several different monomers (a); they do not comprise any monomer (b) or any monomer (c).

Advantageously, the copolymer according to the invention comprises a reduced, small or very small amount by weight of homopolymer of monomer (a) relative to the amount by dry weight of copolymer of monomers (a), (b) and (c). Also advantageously, the copolymer according to the invention comprises a reduced, small or very small amount by weight of copolymer of monomers (a) relative to the amount by dry weight of copolymer of monomers (a), (b) and (c).

According to the invention, the absence or the presence of a reduced, small or very small amount of homopolymer of monomer (a) or of copolymer of monomers (a) makes it possible to avoid or limit the risk of inhibiting the concrete crystallisation when the copolymer according to the invention is used for its plasticising properties in a concrete formulation. Generally, a homopolymer of monomer (a) or a copolymer of monomers (a) has properties that disperse mineral matter particles and can thus disrupt or inhibit crystallisation in a concrete formulation. The properties of the concrete formulation or of the final material prepared using the concrete formulation can thus be changed or altered. Particularly advantageously and particularly effectively, the invention makes it possible to prepare a copolymer from monomers (a), (b) and (c) while controlling the polymerisation reaction of monomers (a), (b) and (c). The invention thus makes it possible to obtain an aqueous composition comprising a very small amount of residual monomer (a) relative to the amount by dry weight of copolymer.

Generally, the presence of residual monomer (a) in a copolymer can disrupt or inhibit crystallisation in a concrete formulation. Very advantageously, the copolymer according to the invention comprises less than 2,000 ppm by weight or less than 1,500 ppm by weight, preferably less than 1,000 ppm by weight or less than 500 ppm by weight, in particular less than 200 ppm by weight or less than 100 ppm by weight, of residual monomer (a) relative to the amount by dry weight of copolymer.

The amount of residual monomers is measured according to techniques known as such, for example by High Performance Liquid Chromatography (HPLC). According to this method, the constituent components of the admixture are separated in a stationary phase and detected by a UV detector. After calibration of the detector, for example from the area of the peak corresponding to the acrylic compound, the amount of residual (meth)acrylic acid can be obtained.

When preparing the copolymer according to the invention, the amounts of monomers (a), (b) and (c) used can vary greatly. Preferably, the polymerisation reaction uses, relative to the total amount of monomers:
from 5 to 28% by weight of monomer (a),
from 68 to 91% by weight of monomer (b) and
from 4 to 27% by weight of monomer (c).

Also preferably, the polymerisation reaction uses, relative to the total amount of monomers:
from 10 to 27% by weight of monomer (a),
from 68 to 85% by weight of monomer (b) and
from 5 to 22% by weight of monomer (c).

Particularly preferably, the copolymer according to the invention comprises, relative to the total amount of monomers:
from 5 to 28% by weight of monomer (a),
from 68 to 91% by weight of monomer (b) and
from 4 to 27% by weight of monomer (c).

Also preferably, the copolymer according to the invention comprises, relative to the total amount of monomers:
from 10 to 27% by weight of monomer (a),
from 68 to 85% by weight of monomer (b) and
from 5 to 22% by weight of monomer (c).

When preparing the copolymer according to the invention, the polymerisation reaction can use one or several of monomers (a), (b) and (c). Preferably according to the invention, the polymerisation reaction uses one monomer (a), one monomer (b) and one monomer (c). Also preferably according to the invention, the polymerisation reaction uses one monomer (a), one monomer (b) and two monomers (c). Also preferably according to the invention, the polymerisation reaction uses one monomer (a), two monomers (b) and one monomer (c).

Preferably according to the invention, the copolymer of the invention is a copolymer obtained by polymerisation of at least one monomer (a), of at least one monomer (b) chosen among a compound (b1) and a compound (b2) and of at least one monomer (c) chosen among a monomer (c1), a monomer (c2) and a monomer (c4). More preferably according to the invention, the copolymer according to the invention is a copolymer obtained by polymerisation of at least one monomer (a), of at least one compound (b1) and of at least one monomer (c) chosen among a monomer (c1) and a monomer (c2).

The invention comprises the use of a radical polymerisation reaction in water of acrylic acid alone or in combination with at least one other monomer chosen among methacrylic acid, maleic acid, maleic anhydride, itaconic acid, 2-acrylamido-2-methylpropane sulphonic acid, 2-acrylamido-2-methylpropane sulphonic, vinylsulphonic acid, 2-(methacryloyloxy)-ethanesulphonic acid, 2-(methacryloyloxy)-ethanesulphonic, sodium methallyl sulphonate, styrene sulphonate and salts thereof. Preferably, monomer (a) is acrylic acid alone or acrylic acid in combination with another monomer (a) chosen among methacrylic acid, itaconic acid, 2-acrylamido-2-methylpropane sulphonic acid, 2-acrylamido-2-methylpropane sulphonic, vinylsulphonic acid, 2-(methacryloyloxy)-ethanesulphonic acid, 2-(methacryloyloxy)-ethanesulphonic, sodium methallyl sulphonate, styrene sulphonate and salts thereof. More preferably, monomer (a) is acrylic acid alone or acrylic acid combined with another monomer (a) chosen among methacrylic acid, maleic acid, maleic anhydride and 2-acrylamido-2-methylpropane sulphonic acid, their salts and combinations thereof. Much more preferably, monomer (a) is acrylic acid alone.

When used according to the invention, acrylic acid can be used in the form of free acrylic acid or in the form of an acrylic acid salt, for example a sodium salt. It can also be used in the form of a combination of free acrylic acid and an acrylic acid salt, for example a sodium salt.

During the radical polymerisation reaction in water, the invention also comprises the use of at least one monomer (b) chosen among a monomer (b1), a monomer (b2) and combinations thereof

The preferred monomer (b) is monomer (b1). The preferred monomer (b1) is a compound of formula (I) wherein n independently represents an integer or decimal comprised between 10 and 120 or between 20 and 120. The more preferred monomer (b1) is a compound of formula (I) wherein n independently represents an integer or decimal comprised between 25 and 95 or between 40 and 85, in particular between 40 and 60 or between 65 and 85.

A particularly preferred monomer (b1) is monomer (b1a) of formula (I) wherein n represents about 53 and L¹ represents EO.

Another particularly preferred monomer (b1) is monomer (b1b) of formula (I) wherein n represents about 78 and L¹ represents EO.

The preferred monomer (b2) is a compound of formula (II) wherein m independently represents an integer or decimal comprised between 10 and 120 or between 20 and 120. The more preferred monomer (b2) is a compound of formula (II) wherein m independently represents an integer or decimal comprised between 25 and 95 or between 40 and 85, in particular between 40 and 60 or between 65 and 85.

During the radical polymerisation reaction in water, the invention also comprises the use of at least one monomer (c) chosen among a monomer (c1), a monomer (c2), a monomer (c3), a monomer (c4) and combinations thereof. The preferred monomers (c) are monomers (c1) and (c2) and combinations thereof.

The preferred monomer (c1) is a compound of formula (III) wherein u independently represents an integer or decimal comprised between 25 and 170 or between 30 and 160. The more preferred monomer (c1) is a compound of formula (III) wherein u independently represents an integer or decimal comprised between 50 and 150.

The preferred monomer (c2) is a compound of formula (IV) wherein v independently represents an integer or decimal comprised between 70 and 140.

The preferred monomer (c3) is a compound of formula (V) wherein w independently represents an integer or decimal comprised between 90 and 140.

The preferred monomer (c4) is a compound of formula (VI) wherein t independently represents an integer or decimal comprised between 70 and 140.

A particularly preferred monomer (c1) is monomer (c1a) of formula (III) wherein u represents about 112, L³ represents EO and R¹ represents H.

The preferred combinations of monomers used in the preparation of the copolymer according to the invention are:
acrylic acid, monomer (b1) and monomer (c1), particularly acrylic acid, monomer (b1a) and monomer (c1a) or acrylic acid, monomer (b1b) and monomer (c1a);
acrylic acid, monomer (b1) and monomer (c2);
acrylic acid, monomer (b1), monomer (c1) and monomer (c2), particularly acrylic acid, monomer (b1a), monomer (c1a) and monomer (c2) or acrylic acid, monomer (b1b), monomer (c1a) and monomer (c2).

Even if it is preferably prepared only from monomers (a), (b) and (c), the copolymer according to the invention can also be prepared from a polymerisation reaction that also uses a non-ionic monomer comprising at least one polymerisable olefinic unsaturation, preferably at least one polymerisable ethylenic unsaturation and in particular a polymerisable vinyl group, more preferentially a non-ionic monomer chosen among the esters of an acid comprising at least one monocarboxylic acid group, in particular an ester of an acid chosen among acrylic acid, methacrylic acid, and mixtures thereof, for example hydroxyethyl acrylate, hydroxypropyl acrylate, hydroxyethyl methacrylate, hydroxypropyl methacrylate.

Preparing the copolymer according to the invention also uses at least one radical-generating compound which is particular. It is preferentially chosen among hydrogen peroxide, ammonium persulphate, sodium persulphate, potassium persulphate, their mixtures or their combinations with an ion chosen among Fe^{II}, Fe^{III}, Cu^{I}, Cu^{II}. According to the invention, the Fe^{II}, Fe^{III}, Cu^{I} or Cu^{II} ions can be used by means of at least one compound chosen among iron sulphate, iron sulphate hydrate, iron sulphate hemihydrate, iron sulphate heptahydrate, iron carbonate, iron carbonate hydrate, iron carbonate hemihydrate, iron chloride, copper carbonate, copper carbonate hydrate, copper carbonate hemihydrate, copper acetate, copper sulphate, copper sulphate pentahydrate, copper hydroxide, copper halide.

According to the invention, the particular radical-generating compound is more preferentially chosen among hydrogen peroxide, ammonium persulphate, sodium persulphate, potassium persulphate, in particular sodium persulphate. According to the invention, the polymerisation reaction can use one or several compounds (i) or one or several compounds (ii). Preferably, the polymerisation reaction uses a single compound (i) or a single compound (ii) or a compound (i) and a compound (ii). Preferably according to the invention, the polymerisation reaction is carried out in the absence of sodium bisulphite and, more preferentially in the absence of sodium bisulphite combined with a compound (ii).

Preparing the aqueous composition according to the invention uses a radical polymerisation reaction that is carried out in water in the presence of at least one compound (i) comprising phosphorus in the I oxidation state. More preferably according to the invention, the polymerisation reaction uses an inorganic compound (i). More preferably according to the invention, the polymerisation reaction uses a compound (i) chosen among hypophosphorous acid (H₃PO₂), a derivative of hypophosphorous acid (H₃PO₂). Even more preferably according to the invention, the polymerisation reaction uses a compound (i) comprising at least one hypophosphite ion (H₂PO₂⁻), more preferentially a compound (i) chosen among sodium hypophosphite (H₂PO₂Na), potassium hypophosphite (H₂PO₂K), calcium hypophosphite ([H₂PO₂]2_{Ca}) and mixtures thereof. Sodium hypophosphite (H₂PO₂Na) is particularly preferred.

The polymerisation reaction according to the invention can also use at least one compound (ii) of formula (A) wherein X independently represents H, Na or K and R independently represents a C₁-C₅-alkyl group. Preferably according to the invention, compound (ii) is a compound of formula (A) wherein R represents a C₁-C₃-alkyl group, preferably a methyl group, and X represents H. The preferred compound of formula (A) according to the invention is disodic diisopropionate trithiocarbonate (DPTTC-CAS number 86470-33-2).

Preferably according to the invention, compound (iii) is used in an amount by weight ranging from 0.05 to 5% by weight, relative to the amount of monomers. Also preferably according to the invention, the polymerisation reaction uses compound (ii) of formula (A) in an amount of from 0.05 to 4% by weight, from 0.05 to 3% by weight, from 0.05 to 2% by weight, from 0.5 to 4% by weight, from 0.5 to 3% by weight, from 0.5 to 2% by weight, from 1 to 4% by weight, from 1 to 3% by weight, from 1 to 2% by weight relative to the amount of monomers.

The copolymer according to the invention has a polymolecularity index P_{I} of less than 3. Preferably according to the invention, the polymolecularity index P_{I} ranges from 1.5 to 3, more preferentially from 1.5 to 2.8, much more preferentially from 1.5 to 2.5.

The copolymer according to the invention is obtained by at least one radical polymerisation reaction in water and at a temperature ranging from 10 to 90° C., preferably ranging from 30 to 85° C., more preferentially at a temperature ranging from 40 to 75° C. or from 50 to 70° C., much more preferentially from 50 to 68° C. or from 50 to 65° C.

More preferably, a single radical polymerisation reaction is carried out.

The copolymer according to the invention can also be characterised by its weight-average molecular mass (M_{W}). Preferably, it has a weight-average molecular mass ranging from 8,000 g/mol to 200,000 g/mol or from 10,000 g/mol to 200,000 g/mol or from 12,000 g/mol to 200,000 g/mol. More preferably, it has a weight-average molecular mass ranging from 15,000 g/mol to 150,000 g/mol or from 15,000 g/mol to 120,000 g/mol or from 15,000 g/mol to 90,000 g/mol or from 15,000 g/mol to 50,000 g/mol.

According to the invention, the molecular weight and polymolecularity index of the copolymers is determined by size exclusion chromatography (SEC). This technique uses a Waters liquid chromatography instrument equipped with a detector. This detector is a Waters refractive index detector. This liquid chromatography instrument is equipped with a size exclusion column in order to separate the various molecular weights of the copolymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the copolymer solution is diluted to 0.9% by dry weight in the dissolution solvent of the SEC, which corresponds to the liquid elution phase of the SEC to which is added 0.04% of dimethyl formamide which acts as a flow marker or internal standard. Then it is filtered using a 0.2 μm filter. Then 100 μL are injected into the chromatograph (eluent: an aqueous phase adjusted to pH 9.00 by 1N sodium hydroxide containing 0.05 M NaHCO₃, 0.1 M NaNO₃, 0.02 M triethanolamine and 0.03% NaN₃).

The liquid chromatography instrument has an isocratic pump (Waters 515) the flow rate of which is set to 0.8 mL/min. The chromatography instrument also comprises an oven which itself comprises the following system of columns in series: a Waters Ultrahydrogel Guard precolumn 6 cm long and 40 mm in inner diameter and a Waters Ultrahydrogel linear column 30 cm long and 7.8 mm in inner diameter. The detection system is comprised of a Waters 410 RI refractive index detector. The oven is heated to 60° C. and the refractometer is heated to 45° C.

Molecular mass is assessed by detection of the dynamic light scattering using a Viscotek 270 dual detector to determine the molecular mass based on the hydrodynamic volume of the copolymer.

The copolymer according to the invention is obtained by radical polymerisation reaction in water. An aqueous composition comprising the copolymer according to the invention is then obtained. The water can be separated in order to obtain the copolymer as such, for example in powder form. The invention therefore also provides an aqueous composition comprising water and at least one copolymer according to the invention.

The particular, advantageous or preferred characteristics of the copolymer according to the invention define aqueous compositions according to the invention which are also particular, advantageous or preferred.

The copolymer and the aqueous composition according to the invention have properties that are particularly advantageous in many technical fields. According to the technical field in which their properties are used, the copolymer or the aqueous composition according to the invention can have different forms. They can therefore be used directly or in combination with other ingredients. They can be used in various formulations. Preferably, these formulations may be hydraulic binder formulations.

Thus, the invention also relates to a formulation (F1) comprising:
at least one copolymer according to the invention;
at least one hydraulic binder; optionally
water; optionally
at least one aggregate; optionally
at least one admixture.

The invention also relates to a formulation (F2) comprising:
at least one aqueous composition according to the invention;
at least one hydraulic binder;
water; optionally
at least one aggregate; optionally
at least one admixture.

Preferably, formulations (F1) and (F2) according to the invention comprise:
from 0.01 to 5% by dry weight of copolymer, respectively in the form of at least one aqueous composition according to the invention or in the form of at least one copolymer according to the invention, as such;
from 95 to 99.9% by dry weight of at least one hydraulic binder.

More preferably, formulations (F1) and (F2) according to the invention comprise:
from 0.01 to 4% by dry weight or from 0.01 to 3% by dry weight of copolymer, respectively in the form of at least one aqueous composition according to the invention or in the form of at least one copolymer according to the invention, as such;
from 96 to 99.9% by dry weight or from 97 to 99.9% by dry weight of at least one hydraulic binder.

Also more preferably, formulations (F1) and (F2) according to the invention comprise:
from 0.03 to 5% by dry weight or from 0.03 to 4% by dry weight or from 0.03 to 3% by dry weight of copolymer, respectively in the form of at least one aqueous composition according to the invention or in the form of at least one copolymer according to the invention, as such;
from 95 to 99.7% by dry weight or from 96 to 99.7% by dry weight or from 97 to 99.7% by dry weight of at least one hydraulic binder.

Also more preferably, formulations (F1) and (F2) according to the invention comprise:
from 0.05 to 5% by dry weight or from 0.05 to 4% by dry weight or from 0.05 to 3% by dry weight or from 0.05% to 2% by dry weight or from 0.05 to 1.5% by dry weight of copolymer, respectively in the form of at least one aqueous composition according to the invention or in the form of at least one copolymer according to the invention, as such;
from 95 to 99.5% by dry weight or from 96 to 99.5% by dry weight or from 97 to 99.5% by dry weight or from 98 to 99.5% by dry weight or from 98.5 to 99.5% by dry weight of at least one hydraulic binder.

Also preferably, formulations (F1) and (F2) according to the invention comprise water in an amount by weight, relative to the amount by weight of hydraulic binder, of less than 0.7, less than 0.65 or less than 0.6, preferably less than 0.5 or less than 0.4, or less than 0.3 or less than 0.2. The amount by weight of water relative to the amount by weight of hydraulic binder in formulations (F1) and (F2) preferably ranges from 0.2 to 0.65 or from 0.2 to 0.6 or from 0.2 to 0.5 or from 0.3 to 0.65 or from 0.3 to 0.6 or from 0.3 to 0.5.

According to the invention, the hydraulic binder or hydrolith can be chosen among cement, mortar, plaster, slurry or concrete.

The cement can be chosen among Portland cement, white Portland cement, artificial cement, blast furnace cement, high strength cement, aluminate cement, quick-setting cement, magnesium phosphate cement, cement based on incineration products, fly ash cement and mixtures thereof.

Other hydraulic binders can be chosen among latent hydraulic binders, pozzolanic binders, ash, slag, clinker.

The plaster can be chosen among gypsum, calcium sulphate dihydrate, calcium sulphate, calcium sulphate hemihydrate, calcium sulphate anhydride and mixtures thereof.

The aggregate can be chosen among sand, coarse aggregate, gravel, crushed stone, slag, recycled aggregate.

Generally, aggregates are classified according to their particle size distribution in several categories known as such by the person skilled in the art, for example according to French standard XP P 18-540. According to this standard, which defines in particular the d and D values, the aggregate families comprise:
0/D fillers for which D<2 mm with at least 70% passing at 0.063 mm,
0/D fine sands for which D≤1 mm with less than 70% passing at 0.063 mm,
0/D sand for which 1<D≤6.3 mm,
0/D gravel-sand mixtures for which D>6.3 mm,
d/D chipping for which d>1 mm and D≤125 mm,
d/D ballast for which d>25 mm and D≤50 mm.

Examples of fillers are silica fume or siliceous additions, or calcareous additions such as calcium carbonate.

According to the invention, the admixture in formulations (F1) or (F2) can be chosen among an anti-foaming agent, a plasticising or superplasticising agent, a workability-enhancing agent, a slump-reducing agent, an air detraining agent, a tincture, a pigment, a water-reducing agent, a setting retarder, a hygroscopicity control agent, an anticorrosion agent, an anti-shrink agent, an alkali-silica reactivity-inhibiting agent, a waterproofing agent, a foaming agent.

The particular properties of the aqueous composition according to the invention or of the copolymer according to the invention make it possible to use them in many technical fields, in particular for their rheology regulation or control properties.

Thus, the invention provides a method of changing the rheology of a hydraulic formulation comprising the addition of at least one aqueous composition according to the invention or of at least one copolymer according to the invention to the hydraulic formulation comprising water and a hydraulic binder.

The properties of the composition according to the invention and of the copolymer are particularly useful in the field of hydraulic formulations.

Thus, the invention provides a method of reducing the water in a hydraulic formulation comprising the addition of at least one aqueous composition according to the invention or of at least one copolymer according to the invention in a hydraulic formulation. According to the invention, the water reduction method is determined in accordance with the ADJUVANT NF EN 934-2 standard.

For the method of reducing the water in a hydraulic formulation according to the invention, the hydraulic formulation is preferably chosen among a hydraulic formulation (F1) and a hydraulic formulation (F2). According to the invention, the water reduction in the hydraulic formulation is determined relative to the amount of water in a hydraulic formulation comprising no copolymer. Preferably according to the invention, the water reduction method according to the invention makes it possible to reduce the amount by weight of water in the hydraulic formulation by at least 15%, preferably by at least 20% or by at least 25%, more preferentially by at least 30% relative to the amount of water in a hydraulic formulation comprising no copolymer.

The particular, advantageous or preferred characteristics of the hydraulic formulations (F1) and (F2) according to the invention define methods for reducing the water in a hydraulic formulation according to the invention which are also particular, advantageous or preferred.

The following examples illustrate the various aspects of the invention.

### EXAMPLE 1: PREPARATION OF COPOLYMERS ACCORDING TO THE INVENTION AND OF A COMPARATIVE COPOLYMER

### Example 1.1: Copolymer (P1) According To The Invention

Water (90 g), a 60% by mass solution of monomer (b1a) with a molecular mass of 2,400 g/mol in water (440.8 g), a 50% solution of comonomer (c1a) with a molecular mass of 5,000 g/mol in water (80g) and sodium hypophosphite hydrate (1.4 g) are placed in a stirred reactor. The reactor is heated to 65±2° C.

Then, for 1 hour, a mixture of water (34.2 g) and of acrylic acid (57.44 g), a mixture of water (34.2 g) and of sodium hypophosphite hydrate (12.57 g) and a mixture of water (13.7 g) and of sodium persulphate (5.6 g) are simultaneously injected into the reactor. The reactor is then kept at a temperature of 65±2° C. for 1 hour.

The product is cooled and then neutralised by adding a 50% by mass aqueous solution of sodium hydroxide (63 g). The aqueous polymeric solution comprises less than 3 ppm of residual dry acrylic acid relative to the total amount of dry copolymer.

A copolymer (P1) is obtained comprising 15.9% by weight of acrylic acid, 73.1% by weight of monomer (b1a) and 11.0% by weight of monomer (c1a). It has a molecular mass M_{W} of 35,000 g/mol and a polymolecularity index P_{I} of 1.9.

### Example 1.2: Copolymer (P2) According To The Invention

Water (90 g), a 60% by mass solution of monomer (b1a) with a molecular mass of 2,400 g/mol in water (420.8 g) and sodium hypophosphite hydrate (1.4 g) are placed in a stirred reactor. The reactor is heated to 65±2° C.

Then, for 1 hour, a mixture of water (34.2 g), of acrylic acid (57.44 g), and of a 50% solution of comonomer (c1a) with a molecular mass of 5,000 g/mol in water (100 g), a mixture of water (34.2 g) and of sodium hypophosphite hydrate (12.57 g), and a mixture of water (13.7 g) and of sodium persulphate (5.6 g) are simultaneously injected into the reactor.

The reactor is then kept at a temperature of 65±2° C. for 1 hour.

The product is cooled and then neutralised by adding a 50% by mass aqueous solution of sodium hydroxide (62.2 g). The aqueous polymeric solution comprises less than 3 ppm of residual dry acrylic acid relative to the total amount of dry copolymer.

A copolymer (P2) is obtained comprising 16.0% by weight of acrylic acid, 70.1% by weight of monomer (b1a) and 13.9% by weight of monomer (c1a). It has a molecular mass M_{W} of 29,000 g/mol and a polymolecularity index P_{I} of 1.5.

### Example 1.3: Copolymer (P3) According To The Invention

Water (90 g), a 60% by mass solution of monomer (b1a) with a molecular mass of 2,400 g/mol in water (400.8 g) and sodium hypophosphite hydrate (1.4 g) are placed in a stirred reactor. The reactor is heated to 65±2° C.

Then, for 1 hour, a mixture of water (34.2 g), of acrylic acid (57.44 g), and of a 50% solution of comonomer (c1a) with a molecular mass of 5,000 g/mol in water (120 g), a mixture of water (34.2 g) and of sodium hypophosphite hydrate (12.57 g), and a mixture of water (13.7 g) and of sodium persulphate (5.6 g) are simultaneously injected into the reactor.

The reactor is then kept at a temperature of 65±2° C. for 1 hour.

The product is cooled and then neutralised by adding a 50% by mass aqueous solution of sodium hydroxide (62.0 g). The aqueous polymeric solution comprises less than 3 ppm of residual dry acrylic acid relative to the total amount of dry copolymer.

A copolymer (P3) is obtained comprising 16.0% by weight of acrylic acid, 67.2% by weight of monomer (b1a) and 16.8% by weight of monomer (c1a). It has a molecular mass M_{W} of 31,000 g/mol and a polymolecularity index P_{I} of 1.3.

### Example 1.4: Copolymer (P4) According To The Invention

Water (30 g), a 60% by mass solution of monomer (b1a) with a molecular mass of 2,400 g/mol in water (440.8 g), a 50% solution of comonomer (c1a) with a molecular mass of 5,000 g/mol in water (80g) and a 20% by mass solution of DPTTC in water (2.54 g) are placed in a stirred reactor. The reactor is heated to 65±2° C. and hydrogen peroxide is added in an aqueous solution at 35% by mass (5.6 g).

Then, for 1 hour and 15 minutes, a mixture of water (34.2 g) and acrylic acid (57.44 g), a mixture of water (76 g) and of a 20% by mass solution of DPTTC in water (10.15 g) are simultaneously injected into the reactor along with a mixture of water (55 g) and ammonium persulphate (2.26 g) in 1 hour and 40 minutes for the latter.

The reactor is kept at a temperature of 65±2° C. for 1 hour.

The product is cooled and then partially neutralised by adding an aqueous solution of sodium hydroxide at 50% by mass (63.5 g). The aqueous polymeric solution comprises less than 15 ppm of residual dry acrylic acid relative to the total amount of dry copolymer. A copolymer (P4) is obtained comprising 15.9% by weight of acrylic acid, 73.1% by weight of monomer (b1a) and 11.0% by weight of monomer (c1a). It has a molecular mass M_{W} of 110,000 g/mol and a polymolecularity index P_{I} of 1.4.

### Example 1.5: Copolymer (P5) According To The Invention

Water (110 g), a 60% by mass solution of monomer (b1a) with a molecular mass of 3,500 g/mol in water (493.3 g), a 50% solution of comonomer (c1a) with a molecular mass of 5,000 g/mol in water (61.16 g) and of sodium hypophosphite hydrate (1.06 g) are placed in a stirred reactor. The reactor is heated to 65±2° C.

Then, for 1 hour, a mixture of water (35.0 g) and of acrylic acid (44.08 g), a mixture of water (40.0 g) and of sodium hypophosphite hydrate (9.52 g) and a mixture of water (40.0 g) and of sodium persulphate (4.25 g) are simultaneously injected into the reactor. The reactor is then kept at a temperature of 65±2° C. for 1 hour.

The product is cooled and then neutralised by adding a 50% by mass aqueous solution of sodium hydroxide (46.3 g). The aqueous polymeric solution comprises less than 10 ppm of residual dry acrylic acid relative to the total amount of dry copolymer.

A copolymer (P5) comprising 11.9% by weight of acrylic acid, 79.9% by weight of monomer (b1b) and 8.2% by weight of monomer (c1a) is obtained. It has a molecular mass M_{W} of 39,000 g/mol and a polymolecularity index P_{I} of 1.6.

### EXAMPLE 2: ASSESSMENT OF WATER-REDUCING PROPERTIES IN MORTAR

Mortar formulations, the compositions of which are shown in Table 1, are prepared according to the following procedure:

incorporating the admixture and the water in the bowl of an automatic Perrier mixer for standardised cements and mortars,
incorporating all the fines (cement and/or hydraulic binders),
mixing at a slow speed of 140 rpm,
incorporating the sand after 30 seconds,
mixing at a slow speed of 140 rpm for 60 seconds,
pausing for 30 seconds to clean the sides of the bowl,
mixing at a slow speed of 140 rpm for 90 seconds.

Similarly, a comparative formulation (CF) of mortar is prepared comprising no copolymer.

The water-reducing properties of the copolymers according to the invention are assessed using the mortar formulations.

The T0 workability of the mortars formulated with the copolymers according to the invention was assessed by measuring the slump flow in accordance with standard EN 12350-2 adapted to mortar (Abrams mini-cone test).

To perform the slump measurement, the cone filled with formulated mortar is lifted perpendicular to a horizontal plate while rotating it one-quarter turn. The slump is measured with a ruler after 5 minutes across two 90° diameters. The result of the slump measurement is the average of the 2 values to ±1 mm.

The tests are conducted at 20° C. The admixture content is determined such that a target slump of 220 mm ±5 mm can be reached. The content is expressed in % by dry weight with respect to the weight of the hydraulic binder or the mixture of hydraulic binders. The results are shown in Table 1.

TABLE 1

| Formulation | CF | According to the invention | |
|---|---|---|---|
| Formulation | CF | F1-1 | F1-2 |
| AFNOR sand (g) | 1,350 | 1,350 | 1,350 |
| BOSTIK CEM I 42.5R cement | 450 | 450 | 450 |
| (g) | | | |
| Copolymer (% by dry weight/ | / | P1 (0.16) | P5 (0.16) |
| dry weight of cement) | | | |
| Anti-foaming agent (%/ | / | 0.5 | 0.5 |
| admixture) | | | |
| Water (g) | 266 | 170 | 170 |
| Water/cement weight ratio | 0.59 | 0.37 | 0.37 |
| T0 workability (mm) | 220 | 220 | 225 |
| Water reduction (%) | 0 | 36 | 36 |

Using the copolymers according to the invention makes it possible to reduce the amount of water in the hydraulic formulations by 36% while maintaining an initial slump level (workability) similar to that of the comparative formulation comprising no copolymer.

The copolymers according to the invention can therefore be classed as highly water-reducing agents according to French standard ADJUVANT NF EN 934-2. Indeed, they make it possible to reduce the water in the admixed mortar by at least 12% relative to the reference mortar.

Using the copolymers according to the invention would make it possible to obtain similar results in admixed concrete by reducing the amount of water by at least 12% relative to a reference concrete comprising no copolymer according to the invention.

1. A copolymer, obtained by a process comprising radically polymerizing, in water at a temperature ranging from 10 to 90° C., and in a reaction environment comprising:
a radical-generating compound comprising hydrogen peroxide, ammonium persulphate, an alkaline metal persulphate, or a mixture thereof, optionally as a combination with an ion comprising Fe^{II}, Fe^{III}, Cu^{I}, and/or Cu^{II}; and
a compound chosen comprising (i) a compound comprising phosphorus in an oxidation state I, and/or (ii) a compound of formula (A): 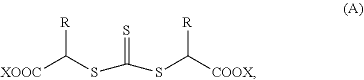
X being H, Na, or K, and R being a C₁-C₅-alkyl group, monomer(s) comprising:
(a) acrylic acid, and optionally further methacrylic acid, maleic acid, maleic anhydride, itaconic acid, 2-acrylamido-2-methylpropane sulphonic acid, 2-acrylamido-2-methylpropane sulphonic, vinylsulphonic acid, 2-(methacryloyloxy)-ethanesulphonic acid, 2-(methacryloyloxy)-ethanesulphonic, sodium methallyl sulphonate, and/or styrene sulphonate, optionally in salt form;
(b1) a compound of formula (I): 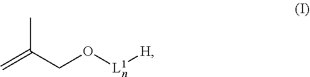
L¹ independently being an EO group or a combination of EO and PO groups, n independently being an integer or decimal in a range of from 20 to 100, EO independently being an ethylene oxide group, and PO independently being a propylene oxide group, and/or (b2) a compound of formula (II): 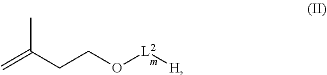
L² independently being an EO group or a combination of EO and PO groups, m independently being an integer or decimal in a range of from 20 to 100,EO independently being an ethylene oxide group, and PO independently being a propylene oxide group; and
(c1) a monomer of formula (III): 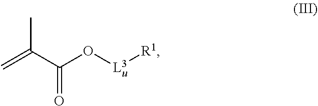
L³ independently being an EO group or a combination of EO and PO groups, u independently being an integer or decimal in a range of from 55 to 150, EO independently being an ethylene oxide group, PO independently being a propylene oxide group, and R¹ independently being H or CH₃,
(c2) a monomer of formula (IV): 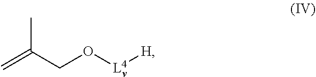
L⁴ independently being an EO group, EO independently being an ethylene oxide group, and v independently represents an integer or decimal in a range of from 50 to 150,
(c3) a monomer of formula (V): 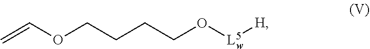
L⁵ independently being an EO group, EO independently being an ethylene oxide group, and w independently represents an integer or decimal in a range of from 85 to 150, and/or
(c4) a compound of formula (VI): 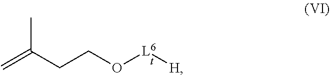
L⁶ independently being an EO group or a combination of EO and PO groups, t independently being an integer or decimal in a range of from 50 to 150 EO independently being an ethylene oxide group and PO independently being a propylene oxide group,
wherein the monomers (c), comprising (c1) to (c4), comprise a total number of EO and PO groups that is 1.3 to 2.5 times greater than a total number of EO and PO groups of monomers (b), comprising (b1) and (b2).

2. The copolymer of claim 1, comprising a reduced amount by weight of homopolymer of monomer (a), or of copolymer of monomers (a), relative to the amount by dry weight of copolymer of the monomers (a), (b), and (c).

3. The copolymer of claim 1, wherein the monomer (a) is the acrylic acid alone, and optionally further methacrylic acid, maleic acid, maleic anhydride, and/or 2-acrylamido-2-methylpropane sulphonic acid, optionally in salt form, or
wherein the monomer (b) is the monomer (b1) and/or the monomer (b2), or
wherein the monomer (b1) is the compound of formula (I), wherein n is independently an integer or decimal in a range of from 30 to 90, or
wherein the monomer (b2) is the compound of formula (II) wherein m is independently an integer or decimal in a range of from 30 to 90, or
wherein the monomer (c) is the monomer(s) (c1) and/or (c2), or
wherein the monomer (c1) is the compound of formula (III) wherein u is independently an integer or decimal in a range of from 25 to 170, or
wherein the monomer (c2) is the compound of formula (IV) wherein v is independently an integer or decimal in a range of from 70 to 140, or
wherein the monomer (c3) is the compound of formula (V) wherein w is independently an integer or decimal in a range of from 90 to 140, or
wherein the monomer (c4) is the compound of formula (VI) wherein t is independently an integer or decimal in a range of from 70 to 140.

4. The copolymer of claim 1, in which the polymerizing uses, relative to total monomer weight:
the monomer (a) in an amount of from 5 to 28 wt. %;
the monomer (b) in a range of from 68 to 91 wt. %; and
the monomer (c) in a range of from 4 to 27 wt. %.

5. The copolymer of claim 1, comprising, relative to total monomer weight:
the monomer (a) in an amount of from 5 to 28 wt. %;
the monomer (b) in a range of from 68 to 91 wt. %; and
the monomer (c) in a range of from 4 to 27 wt. %.

6. The copolymer of claim 1, comprising less than 2,000 ppm by weight or less than 1,500 ppm by weight of residual monomer (a) relative to dry copolymer weight of copolymer.

7. The copolymer of claim 1, wherein the polymerizing uses:
a compound (i) that is inorganic or of hypophosphorus acid (H₃PO₂) or a derivative of hypophosphorus acid (H₃PO₂), or
the compound (ii) of formula (A) wherein X is H and R is a methyl group.

8. The copolymer of claim 1, wherein the monomers (c) comprise a total number of EO and PO groups that is 1.4 to 2.5 times greater than the total number of EO and PO groups of the monomers (b), or
wherein the number of EO groups is greater than the total number of PO groups.

9. The copolymer of claim 1, wherein the polymerizing is carried out at a temperature in a range of from 30 to 85° C.

10. The copolymer of claim 1, wherein the polymering is carried out in the presence of from 0.05 to 5% by weight, relative to monomer weight, of at least one of the compound (ii) of formula (A), or the compound (i) and the compound (ii).

11. An aqueous composition, comprising:
water; and
the copolymer of claim 1.

12. A formulation, comprising:
the copolymer of claim 1; and
a hydraulic binder; and
optionally further comprising water, an aggregate, and/or an admixture.

13. A formulation, comprising:
the aqueous composition of claim 11;
a hydraulic binder; and
water; and
optionally further comprising an aggregate and/or an admixture.

14. The formulation of claim 12, comprising:
the copolymer in a range of from 0.01 to 5% by dry weight; and
a hydraulic binder in a range of from 95 to 99.9% by dry weight.

15. The formulation of claim 12, comprising the water in an amount by weight, relative to hydraulic binder weight, of less than 0.7.

16. A method of changing the rheology of a hydraulic formulation, the method comprising:
adding the copolymer of claim 1 the hydraulic formulation.

17. A method of reducing water in a hydraulic formulation, the method comprising:
adding the copolymer of claim 1 to the hydraulic formulation.

18. The method of claim 17, wherein a weight of water in the hydraulic formulation is reduced by at least 15%, relative to the weight of water in a hydraulic formulation not comprising any copolymer.
